(19) United States
(12) Patent Application Publication
(10) Pub. No.: US 2009/0109969 A1
(43) Pub. Date: Apr. 30, 2009

(54) Dynamic Routing of Wideband and Narrowband Audio Data in a Multimedia Terminal Adapter

(75) Inventors: Christopher J. Cotignola, Doylestown, PA (US); Jacob Igval, Newtown, PA (US); Dipak R. Patel, Hatboro, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/930,441

(22) Filed: Oct. 31, 2007

(51) Int. Cl. H04L 12/56; H04B 1/66; H04J 3/00

(52) U.S. Cl. 370/389; 370/498; 375/240; 375/241

(57) ABSTRACT

A multi-media terminal adapter includes a narrowband SLIC and a wideband SLIC. A DSP circuit is configured to encode a VoIP data stream and to transmit the encoded VoIP data stream to the wideband SLIC or the narrowband SLIC. A processor determines whether the VoIP data stream includes narrowband audio data or wideband audio data, and instructs the DSP circuit to transmit the encoded VoIP data stream to the wideband SLIC or the narrowband SLIC depending on whether the received VoIP data stream includes narrowband audio data or wideband audio data.

### BACKGROUND

Plain Old Telephone Systems (POTS) represent the traditional type of analog phone service. POTS using the public switched telephone network (PSTN) to route calls. When a call is made, the telephone converts the caller's voice to analog electrical signals, which are transmitted over the local loop to a central office. The analog signals are converted to digital signals at the central office and transmitted over the PSTN to a central office local to the callee. The digital signals are converted to analog signals and sent to the callee's telephone via a local loop.

Typically, a codec at the central office converts the analog voice signals to 64 kbs, digital, voice streams transmitted in the PSTN. The sampling rate for digitizing voice is 8 kHz for transmission in the PSTN, and frequencies below 200 Hz and above 3.4 kHz in the analog signals are filtered out. The 200 Hz to 3.4 kHz range is referred to as the narrowband. Better voice quality can be achieved by increasing the sampling rate and by sampling a greater frequency range. However, because of the limited capacity of the PSTN, the standard 64 kbs digital voice streams are beneficial to prevent overloading the PSTN.

With the advances of voice over Internet Protocol (VoIP), where digital audio data is transmitted over the Internet, greater bandwidth is available for transmitting audio data between the caller and the callee. Accordingly, the concept of wideband telephony has gained increased awareness. Wideband telephony encompasses a frequency range from 50 Hz to 7 kHz, as opposed to the narrowband range of 200 Hz to 3.4 kHz traditionally used in POTS. Also, the sampling rate of wideband telephony, e.g., 16 kHz, can be approximately double the sampling rate of POTS. Thus, the sound quality of wideband telephony tends to be much better.

Conventionally, VoIP service is provided at the customer premises using a cable or DSL modem and a multi-media terminal adapter (MTA). The MTA interfaces with an IP network and is operable to adapt VoIP data for use by customer premises equipment (CPE), such as telephones, connected to the subscriber line via home wiring. The MTA may be an embedded MTA (eMTA), which is an MTA and a modem incorporated in a single device, or the MTA may be provided as a standalone device connected to a modem.

An MTA typically include subscriber line interface circuits (SLICs) and a digital signal processing (DSP) circuit for providing VoIP service. The SLIC emulates the functions of a central office. For example, the SLIC generates a line voltage on a loop line at the customer premises, which is typically provided by a telephone central office for traditional POTS service. For example, on-hook and off-hook voltages, also referred to as tip and ring voltages, are generated by the SLIC.

As the popularity of wideband audio data increases, service providers need to deploy equipment that is capable of providing wideband audio services. For example, MTAs need to be modified to include SLICs that can supply wideband audio data to the customer premises equipment. Traditionally, MTAs include two narrowband SLICs, and service providers may simply replace all the narrowband SLICs with wideband SLICs. However, a wideband SLIC is typically more expensive than a narrowband SLIC, so replacing all narrowband SLICs with wideband SLICs is costly. Furthermore, the majority of audio data received at the MTA may be narrowband, and thus replacing all the narrowband SLICs may be unnecessary.

### SUMMARY

According to an embodiment, a multi-media terminal adapter includes a narrowband SLIC and a wideband SLIC. A DSP circuit is configured to encode a VoIP data stream and to transmit the encoded VoIP data stream to the wideband SLIC or the narrowband SLIC. A processor determines whether the VoIP data stream includes narrowband audio data or wideband audio data, and instructs the DSP circuit to transmit the encoded VoIP data stream to the wideband SLIC or the narrowband SLIC depending on whether the received VoIP data stream includes narrowband audio data or wideband audio data.

### BRIEF DESCRIPTION OF THE DRAWINGS

Embodiments are illustrated by way of example and not limited in the following Figure(s), in which like numerals indicate like elements, in which:

FIG. 1 illustrates an MTA, according to an embodiment;

FIG. 2 illustrates a system using the MTA, according to an embodiment; and

FIGS. 3A-B illustrate a method for dynamically routing wideband and narrowband audio data in an MTA, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

According to an embodiment, an MTA includes one or more wideband SLICs and one or more narrowband SLICs. The MTA dynamically routes wideband and narrowband audio data between a DSP circuit and the SLICs depending on whether the data includes wideband audio data or narrowband audio data. A selection process is implemented to select a channel for transmitting VoIP data to the appropriate SLIC, i.e., either a wideband SLIC or a narrowband SLIC. Because the selection process is implemented, only a subset of the narrowband SLICs in an existing MTA may be changed to a wideband SLIC, which saves costs. Without the selection process, the DSP circuit may arbitrary pick a channel, which may result in wideband audio data being sent to a narrowband SLIC that is unable to process the wideband audio data.

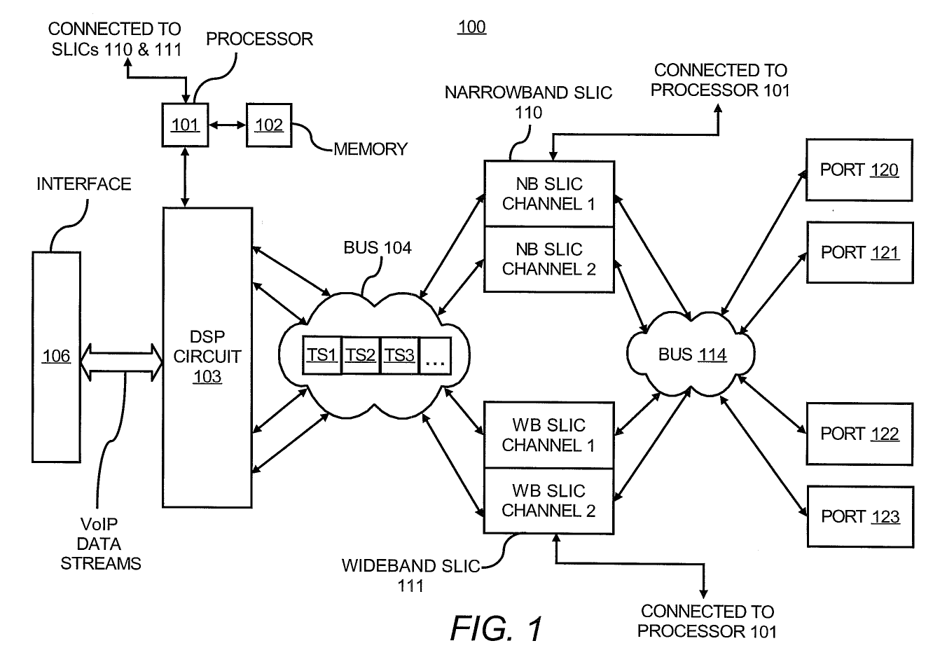

FIG. 1 illustrates an MTA 100 according to an embodiment. The MTA 100 may be a standalone MTA or an eMTA. The MTA 100 includes an interface 1 06and VoIP data streams for calls are received via the interface 106 and are transmitted to the interface 106. The interface 106 may be connected to a IP network, such as the Internet, and may include a modem.

The MTA 100 includes a processor 101 and a computer readable medium storing software executed by the processor 101. The computer readable medium may be comprised of a memory 102. The software includes a call control layer that instructs a DSP circuit 103 to send data from received VoIP data streams to either a narrowband SLIC 110 or a wideband SLIC 111 depending on whether the data includes wideband audio data or narrowband audio data.

The DSP circuit 103 processes the received VoIP data streams for transmission to the narrowband SLIC 110 and the wideband SLIC 111. For example, the DSP circuit 103 may include a CODEC converting received VoIP data streams to a format for transmission on a bus 104 to the narrowband SLIC 110 and the wideband SLIC 111. The format may include pulse code modulation (PCM).

In addition, according to an embodiment, the DSP circuit 103 dynamically transmits VoIP data to the narrowband SLIC 110 and the wideband SLIC 111. The bus 104 is shown as a cloud to illustrate that the bus may accommodate multiple channels and that the channels are dynamically selected as described above. For example, the bus 104 is a serial data bus. The DSP circuit 103 transmits data on the bus 104 to the narrowband SLIC 110 and the wideband SLIC 111 using time division multiplexing (TDM).

As is known in the art, TDM provides a plurality of time slots which act as time multiplexed channels during which transmissions may be transmitted and received on the bus. Time slots are shown in the bus 104 as TS1, TS2, TS3, . . . . Channels comprised of predetermined time slots for transmitting data, such as the pulse code modulated VoIP data streams, are pre-allocated to different SLICs. For example, FIG. 1 shows a 4-channel DSP circuit 103, and each of the SLICs 110 and 111 is capable of handling two channels. The channels are shown as narrowband SLIC channels 1 and 2 and wideband SLIC channels 1 and 2. narrowband SLIC channels 1 and 2 and wideband SLIC channels 1 and 2 are allocated to the narrowband SLIC 110 and the wideband SLIC 111 respectively, and each of the channels is comprised of pre-allocated time slots. For example, time slots 1, 5, 9, etc., are assigned to narrowband SLIC channel 1, and the DSP circuit 103 transmits data for narrowband SLIC channel 1 in these time slots to the narrowband SLIC 110. The narrowband SLIC 110 retrieves data in these time slots. Time slots 2, 6, 10, etc., are for narrowband SLIC channel 2, and the DSP circuit 103 transmits data for narrowband SLIC channel 2 in these time slots to the narrowband SLIC 110. The narrowband SLIC 110 retrieves data in these time slots. Similarly, times slots 3, 7, 11, etc are for wideband SLIC channel 1, and time slots 4, 8, 12, etc., are for wideband SLIC channel 2. The wideband SLIC 111 retrieves data in these time slots for wideband SLIC channels 1 and 2. Data may be transmitted to the SLICs 110 and 111 from the DSP circuit 103 in the pre-allocated time slots, or data may be transmitted from the SLICs 110 and 111 to the DSP circuit 103 in the pre-allocated time slots.

To dynamically transmit data to a particular SLIC, the processor 101 determines the type of data in a VoIP data stream and selects a particular SLIC to receive the data depending on the data type. For example, if a VoIP data stream includes narrowband audio data, the processor 101 selects a narrowband SLIC channel and instructs the DSP circuit 103 to place the VoIP data in time slots for the selected channel. If a VoIP data stream includes wideband audio data, the processor 101 selects a wideband SLIC channel and instructs the DSP circuit 103 to place the VoIP data in time slots for the selected channel. Then, the data is transmitted to the corresponding SLIC on the bus 104.

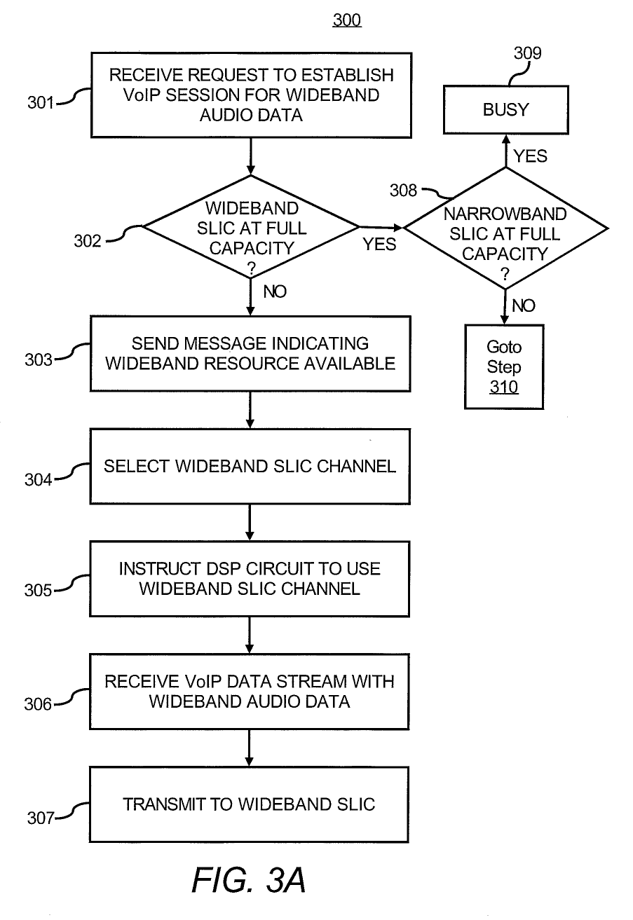

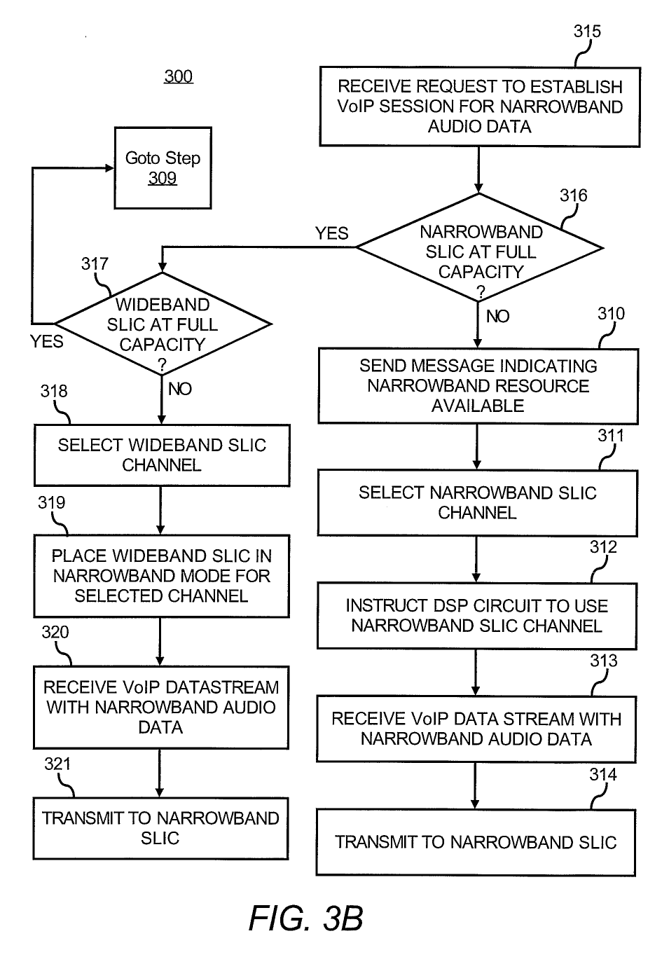

The wideband SLIC 111 may be configured to operate in wideband mode to process wideband data or in a narrowband mode to process narrowband data. If narrowband SLIC channels 1 and 2 are full, for example, because the channels are currently being used for two narrowband calls, and a VoIP data stream including narrowband audio data for a third call is received, the processor 101 may instruct the DSP circuit 103 to send the narrowband audio data for the third call to the wideband SLIC 111. Thus, if the narrowband SLIC 110 is at full capacity, then the wideband SLIC 111 may be used for additional narrowband calls. Note that the narrowband SLIC 110 may not be able to process wideband audio data. Also, if the wideband SLIC 111 is at full capacity, then the narrowband SLIC 110 will be used to process the VoIP data stream. According to an embodiment, whether a wideband SLIC or a narrowband SLIC is to be used for processing a VoIP data stream for a call is dependent on the wideband or narrowband resources available at each party's MTA. For example, the MTAs of the parties involved in the call pre-negotiate whether to use wideband or narrowband resources for a call before sending the VoIP data stream based on their resource availability at that time. This is described in further detail with respect to FIG. 3.

The narrowband SLIC 110 and the wideband SLIC 111 process narrowband audio data and wideband audio data respectively. This may include performing analog-to-digital conversions or digital-to-analog conversions, sampling at the respective rates (e.g., 16 kHz for wideband and 8 kHz for narrowband), and performing other conventional SLIC functions, such as generating tip and ring line voltages, detecting on-hook, off-hook status of a loop line at the customer premises, etc.

The narrowband SLIC 110 and the wideband SLIC 111 are connected to ports 120-123. One or more of the ports 120-123 may be connected to wiring at the customer premises, such as a loop line at the customer premises. For example, the loop line may include a conventional twisted-pair loop in the customer premises, where customer premises equipment (CPE), such as telephones, fax machines, etc., may be connected. The ports may include RJ-11 ports for connecting to a wired interface. One or more of the ports 120-123 may include wireless interfaces, and CPE may interface with these wireless interfaces to send and receive data.

The narrowband SLIC 110 and the wideband SLIC 111 are connected to the ports 120-123 via a bus 114. The bus 114 is shown as a cloud because in one embodiment the narrowband SLIC 110 and the wideband SLIC 111 may dynamically send data to different ports. For example, the ports 120-123 are individually addressable by the narrowband SLIC 110 and the wideband SLIC 111. The narrowband SLIC 110 and the wideband SLIC 111 may be programmed to send narrowband audio data or wideband audio data to a specific port by addressing the port. Thus, if CPE that is wideband-audio-capable is connected to port 123, the wideband SLIC 111 may be programmed to send wideband audio data, for example, from wideband SLIC channels 1 or 2 to port 123. Similarly, the narrowband SLIC 110 may be programmed to send narrowband audio data to a particular port.

The processor 101 may be connected to the narrowband SLIC 110 and the wideband SLIC 111 to instruct the narrowband SLIC 110 and the wideband SLIC 111 to send data to a particular one of the ports 120-123. Programming the narrowband SLIC 110 and the wideband SLIC 111 may be performed automatically via the processor 101 or may be performed in response to a user selection via the processor 101. For example, the processor 101 may automatically detect that a call is being made from a wideband-capable telephone connected to port 123 or that a call is being received by a wideband-capable telephone connected to port 123. Then, the processor 101 instructs the wideband SLIC 111 to send data to the port 123. Also, a user may configure the SLIC to send data to a particular port. For example, the MTA 100 may be connected to wireless local area network (WLAN) at the customer premises and has its own IP address in the WLAN. The user may login to the MTA 100 via the WLAN and configure MTA settings, including identifying which port is connected to wideband-capable customer premises equipment (CPE).

In another embodiment, the narrowband SLIC 110 and the wideband SLIC 111 cannot select a port to send data to and receive information from. Instead, each SLIC input/output is connected to a particular port. For example, the narrowband SLIC 110 has 2 channel outputs which may be connected to ports 120 and 121 respectively.

It will be apparent to one of ordinary skill in the art that the MTA 100 may include more than one narrowband SLIC and more than one wideband SLIC. Furthermore, a DSP circuit may be used that can accommodate more than 4 channels. Furthermore, the narrowband SLIC 110 and the wideband SLIC 111 are shown as 2-channel SLICs by way of example. Also, more than four ports connected to the customer premises may be provided.

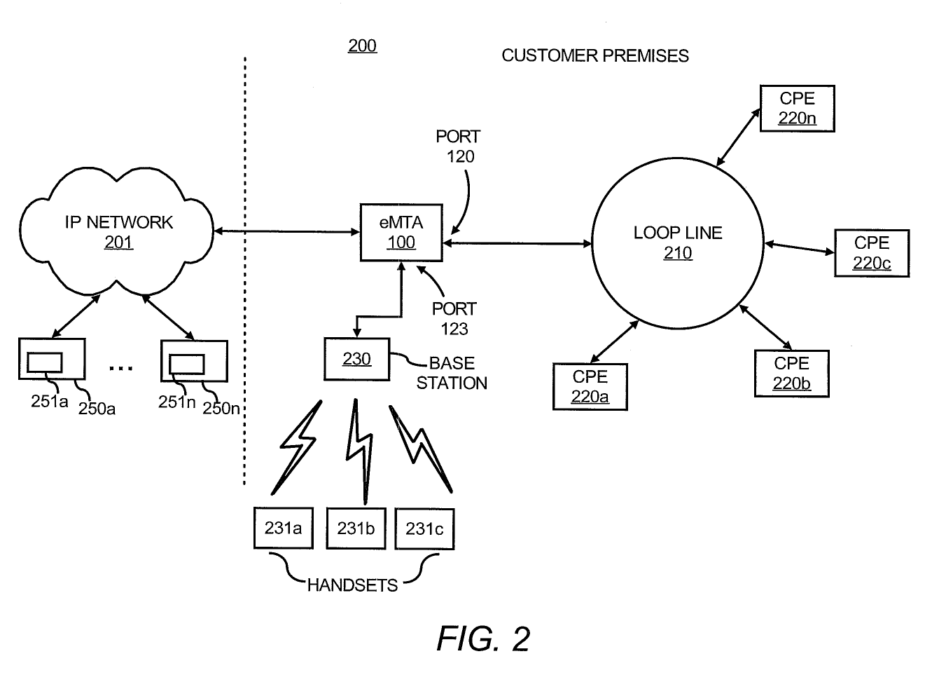

FIG. 2 illustrates a system 200 including the MTA 100, according to an embodiment. The MTA 100 is shown as an eMTA connected to an IP network 201, which may include the Internet. The MTA 100 sends data from a customer premises 201 to the IP network 201 and receives data from the IP network 201 for the customer premises 201. The data may include VoIP data streams. The MTA 100 may exchange information and establish VoIP sessions with MTAs at other customer premises, such as the MTAs 251a-n in the customer premises 250a-n.

The MTA 100 is connected to CPE 220a-n and 230 via ports 120-123. Port 120 is shown as connected to a loop line 210 at the customer premises, and the CPE 220a-n are connected to the loop line 210. For example, the CPE 220a may include a telephone. The MTA 100 receives a VoIP data stream for a telephone call including narrowband audio data. The DSP circuit 103 sends the narrowband audio data for the call to the narrowband SLIC 110, and the narrowband SLIC 110 sends the data to the CPE 220a-n connected to port 120 via the loop line 210.

The ports 120-123 in the MTA 100 may also be connected to CPE via other wired or wireless connections. For example, a cordless telephone system comprising a base station 230 and handsets 231a-c may be connected to the MTA 100. For example, the base station 230 is connected to the MTA 100 via port 123. The base station may be connected to the port 123 via a wireless or wired connection. The handsets 231a-c communicate with the base station 230 to make and receive calls. The cordless telephone system may be a wideband-capable device. Thus, the wideband SLIC 111 in the MTA 100 may send data to and receive data from the cordless base station 230. Although not shown, it will be apparent to one of ordinary skill in the art that other devices and multiple loop lines may be connected to the MTA 100 via the ports. Also, note that only some of the ports 120-123 in the MTA 100 from FIG. 1 are shown in FIG. 2.

FIGS. 3A-B illustrate a method 300 for dynamically routing wideband and narrowband audio data in an MTA, according to an embodiment. The method 300 is described by way of example and not limitation with respect to one or more of FIGS. 1 and 2, and the method 300 may be practiced in other systems and devices.

The method 300 provides steps for dynamically routing wideband and narrowband audio data in an MTA for two scenarios. One scenario is described with respect to step 301, whereby the MTA 100 receives signaling to establish a VoIP session for wideband audio data. The signaling is part of a pre-negotiation between the MTAs with regard to resource availability for the VoIP session. The MTA 250a shown in FIG. 2 is requesting to setup a VoIP session with the MTA 100 for a wideband telephone call. Another scenario is described with respect to step 315, whereby the MTA 100 receives signaling to establish a VoIP session for narrowband audio data. For example, the MTA 251a shown in FIG. 2 is requesting to setup a VoIP session with the MTA 100 for a narrowband telephone call. It will be apparent to one of ordinary skill in the art that many of the steps in the method 300 can be performed if the MTA 100 is attempting to initiate a VoIP call. For example, if a VoIP call is being placed from the MTA 100 to the MTA 251a, and the MTA 100 has a wideband SLIC channel available, the MTA 100 sends a signaling message to the MTA 251a requesting a VoIP session for wideband audio data. Similarly, the MTA may request a VoIP session for narrowband audio data if no wideband SLIC channels are available or if the MTA 251a is only capable of handling narrowband audio data.

At step 301, the MTA 100 is requested to establish a VoIP session for wideband audio data. For example, the MTA 100 receives a signaling message to establish a VoIP session for a call with another MTA 251a shown in FIG. 2. Signaling messages include information about the type of codec (which is layer 6), the type of client (layer 7), and the IP addresses and port (layers 3 and 4). For example, the signaling message indicates that the MTA 251a has wideband resources available and is capable of sending wideband audio data. Session Initiation Protocol (SIP) may be used for sending/receiving signaling messages.

At step 302, the processor 101 determines whether the wideband SLIC 111 is at full capacity. For example, the processor 101 in the MTA 100 keeps track of which resources are available and which resources are unavailable at the MTA 100. The processor 101 may maintain a table of available and unavailable SLIC channels in the memory 102 shown in FIG. 1. The processor 101 determines whether any wideband SLIC channels are available.

At step 303, if the wideband SLIC 111 is not at full capacity, the processor 101 sends a message to the MTA 251a indicating that wideband resources are available and for establishing a VoIP session with the MTA 251a for sending wideband audio data.

At step 304, a wideband SLIC is selected at the MTA 100. This may include selecting a wideband SLIC channel, including pre-allocated timeslots, for sending the VoIP data stream from the DSP circuit 103 to the wideband SLIC 111. For example, the processor 101 selects the wideband SLIC 111 and wideband SLIC channel 1 for sending the VoIP data stream on the bus 104 to the wideband SLIC 111. This information may be used to select a SLIC channel for sending data to a SLIC.

At step 305, the DSP circuit 103 is instructed to use the selected wideband SLIC channel. For example, the processor 101 selects the wideband SLIC channel 1 that is available, and instructs the DSP circuit 103 to use the wideband SLIC channel 1 to send the VoIP data stream to the wideband SLIC 111.

At step 306, the VoIP data stream including the wideband audio data is received at the MTA 100.

At step 307, the VoIP data stream including the wideband audio data is transmitted on the selected channel to the wideband SLIC. For example, the DSP circuit 103 time division multiplexes the VoIP data stream using the slots for wideband SLIC channel 1 to transmit the VoIP data stream to the wideband SLIC 111.

If the processor 101 determines that the wideband SLIC 111 is at full capacity at step 302, the processor 101 determines whether the narrowband SLIC 110 is at full capacity at step 308. If the narrowband SLIC 110 is also at full capacity, then no resources are available and the lines are busy (step 309). For example, if all the SLIC channels in the MTA 100 are being used, then the processor 101 sends a signaling message to the MTA 251a indicating a busy signal (i.e., that no resources are available at this time). If the narrowband SLIC 110 is not at full capacity at step 308, then the processor 101 sends a signaling message to the MTA 25 1a indicating that wideband resources are not available and that narrowband resources are available (step 310) to establish a VoIP session.

At step 311, the processor 101 selects an available narrowband SLIC channel for sending the VoIP data stream to the narrowband SLIC 110.

At step 312, the DSP circuit 103 is instructed to use the selected narrowband SLIC channel. For example, the processor 101 selects the narrowband SLIC channel 1 that is available, and instructs the DSP circuit 103 to use the narrowband SLIC channel 1 to send the VoIP data stream to the narrowband SLIC 110.

At step 313, the VoIP data stream including the narrowband audio data is received at the MTA 100.

At step 314, the VoIP data stream including the narrowband audio data is transmitted on the selected channel to the narrowband SLIC. For example, the DSP circuit 103 time division multiplexes the VoIP data stream using the slots for wideband SLIC channel 1 to transmit the VoIP data stream to the narrowband SLIC 110.

Step 315 describes the second scenario, whereby the MTA 100 receives signaling to establish a VoIP session for narrowband audio data. For example, the MTA 251a shown in FIG. 2 is requesting to setup a VoIP session with the MTA 100 for a narrowband telephone call.

At step 316, the processor 101 determines whether the narrowband SLIC 110 is at full capacity. If the narrowband SLIC is not at full capacity, then steps 310-314 are performed, such as described above. If the narrowband SLIC 110 is at full capacity, then at step 317, the processor 101 determines whether the wideband SLIC 111 is at full capacity. If the wideband SLIC 111 is also at full capacity, then no resources are available, and a signaling message is sent to the MTA 251a indicating that the MTA is busy at step 309. If the wideband SLIC 111 is not at full capacity, then steps 318-321 are performed.

At step 318, a wideband SLIC channel is selected. Also, a signaling message is sent to the MTA 251a indicating that narrowband resources are available. At step 319, the processor 101 places the wideband SLIC 111 in narrowband mode for the selected channel. Thus, the wideband SLIC is operable to process narrowband audio data received on the selected channel.

At step 320, the MTA receives the VoIP data stream including narrowband audio data. At step 321, the VoIP data stream including the narrowband audio data is transmitted on the selected channel to the narrowband SLIC 110.

One or more of the steps of the method 300 and other steps described herein and software described herein may be implemented as software embedded or stored on a computer readable medium. The steps may be embodied by a computer program, which may exist in a variety of forms both active and inactive. For example, they may exist as software program(s) comprised of program instructions in source code, object code, executable code or other formats for performing some of the steps when executed. Modules include software, such as programs, subroutines, objects, etc. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A multi-media terminal adapter comprising:
at least one narrowband subscriber line interface circuit (SLIC);
at least one wideband SLIC;
a digital signal processing (DSP) circuit configured to encode a voice over Internet Protocol (VoIP) data stream and to transmit the encoded VoIP data stream to the at least one wideband SLIC or the at least one narrowband SLIC; and
a processor determining whether the VoIP data stream includes narrowband audio data or wideband audio data, and instructing the DSP circuit to transmit the encoded VoIP data stream to the at least one wideband SLIC or the at least one narrowband SLIC depending on whether the received VoIP data stream includes narrowband audio data or wideband audio data.

2. The multi-media terminal adapter of claim 1, wherein the DSP circuit time division multiplexes the encoded VoIP data stream on a bus for transmission to the at least one wideband SLIC or the at least one narrowband SLIC, and time slots for the time division multiplexing are pre-allocated to the at least one wideband and narrowband SLICs, and
wherein the processor instructs the DSP circuit to transmit the encoded VoIP data stream in the time slots corresponding to the at least one wideband SLIC if the processor determines the encoded VoIP data stream is to be transmitted to the at least one wideband SLIC, and the processor instructs the DSP circuit to transmit the encoded VoIP data stream in the time slots corresponding to the at least one narrowband SLIC if the processor determines the encoded VoIP data stream is to be transmitted to the at least one narrowband SLIC.

3. The multi-media terminal adapter of claim 1, wherein the at least one wideband SLIC is configured to process wideband audio data and narrowband audio data.

4. The multi-media terminal adapter of claim 3, wherein if the at least one narrowband SLIC is at full capacity and the processor determines the received VoIP data stream is to include narrowband audio data, the processor instructs the DSP to transmit the encoded VoIP data stream to the at least one wideband SLIC.

5. The multi-media terminal adapter of claim 3, wherein if the at least one wideband SLIC is at full capacity and the processor determines the received VoIP data stream is to include wideband audio data, the processor instructs the DSP to transmit the encoded VoIP data stream to the at least one narrowband SLIC.

6. The multi-media terminal adapter of claim 1, wherein the DSP circuit encodes the VoIP data stream using pulse code modulation (PCM).

7. The multi-media terminal adapter of claim 1, wherein multiple VoIP data streams are time division multiplexed on a PCM bus between the DSP circuit and the at least one wideband SLIC and the at least one narrowband SLIC.

8. The multi-media terminal adapter of claim 1, further comprising:
ports connected to customer premises equipment, wherein the at least one wideband SLIC and the at least one narrowband SLIC are connected to the ports to transmit received VoIP data streams to the customer premises equipment.

9. The multi-media terminal adapter of claim 8, wherein the at least one wideband SLIC is configured to send wideband audio data to a particular one of the ports.

10. The multi-media terminal adapter of claim 8, wherein the at least one wideband SLIC and the at least one narrowband SLIC dynamically route data to one of the plurality of ports based on whether the data includes wideband audio data or narrowband audio data.

11. The multi-media terminal adapter of claim 1, wherein the multi-media terminal adapter is a standalone device.

12. The multi-media terminal adapter of claim 1, wherein the multi-media terminal adapter is an embedded multi-media terminal adapter incorporated in a single device with a modem.

13. A method of dynamically routing a VoIP data stream to a wideband or narrowband SLIC in a multi-media terminal adapter, the method comprising:
determining whether a VoIP data stream is to include wideband audio data or narrowband audio data;
selecting either a wideband SLIC or a narrowband SLIC to receive the VoIP data stream depending on whether the VoIP data stream is to include wideband audio data or narrowband audio data;
instructing a DSP circuit encoding the VoIP data stream to transmit the encoded VoIP data stream to the selected wideband or narrowband SLIC; and
transmitting the encoded VoIP data stream to the selected wideband or narrowband SLIC.

14. The method of claim 13, wherein selecting either a wideband SLIC or a narrowband SLIC to receive the VoIP data stream comprises:
selecting the wideband SLIC to receive the encoded VoIP data stream if the VoIP data stream is to include wideband audio data; and
selecting the narrowband SLIC to receive the encoded VoIP data stream if the VoIP data stream is to include narrowband audio data.

15. The method of claim 14, wherein selecting either a wideband SLIC or a narrowband SLIC to receive the VoIP data stream comprises:
if the narrowband SLIC is at full capacity and the received VoIP data stream is to include narrowband audio data, selecting the wideband SLIC; and
if the wideband SLIC is at full capacity and the received VoIP data stream is to include wideband audio data, selecting the at least one narrowband SLIC and sending a message requesting the VoIP data stream to include narrowband audio data.

16. The method of claim 13, wherein, wherein the DSP circuit time division multiplexes the encoded VoIP data stream on a bus for transmission to the wideband SLIC or the narrowband SLIC, and time slots for the time division multiplexing are pre-allocated to the wideband SLIC and the narrowband SLIC, and instructing a DSP circuit encoding the VoIP data stream to transmit the encoded VoIP data stream to the selected wideband SLIC or narrowband SLIC comprises:
instructing the DSP circuit to transmit the encoded VoIP data stream in time slots corresponding to the selected SLIC.

17. The method of claim 13, further comprising:
dynamically routing data from the selected SLIC to one of a plurality of ports based on whether the data includes wideband audio data or narrowband audio data.

18. A computer program embedded on a computer readable storage medium, the computer program including instructions for performing a method of dynamically routing a VoIP data stream to a wideband or narrowband SLIC in a multi-media terminal adapter, the method comprising:
determining whether a VoIP data stream is to include wideband audio data or narrowband audio data;
selecting either a wideband SLIC or a narrowband SLIC to receive the VoIP data stream depending on whether the VoIP data stream is to include wideband audio data or narrowband audio data;
instructing a DSP circuit encoding the VoIP data stream to transmit the encoded VoIP data stream to the selected wideband or narrowband SLIC; and
transmitting the encoded VoIP data stream to the selected wideband or narrowband SLIC.

19. The computer program of claim 18, wherein selecting either a wideband SLIC or a narrowband SLIC to receive the VoIP data stream comprises:
selecting the wideband SLIC to receive the encoded VoIP data stream if the VoIP data stream is to include wideband audio data; and
selecting the narrowband SLIC to receive the encoded VoIP data stream if the VoIP data stream is to include narrowband audio data.

20. The computer program of claim 19, wherein selecting either a wideband SLIC or a narrowband SLIC to receive the VoIP data stream comprises:
if the narrowband SLIC is at full capacity and the received VoIP data stream is to include narrowband audio data, selecting the wideband SLIC; and
if the wideband SLIC is at full capacity and the received VoIP data stream is to include wideband audio data, selecting the at least one narrowband SLIC and sending a message requesting the VoIP data stream to include narrowband audio data.
